(19) United States
(12) Patent Application Publication
(10) Pub. No.: US 2003/0098390 A1
(43) Pub. Date: May 29, 2003

(54) Airborne rescue apparatus

(76) Inventor: Peter Cyrus, Seattle, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 09/996,018

(22) Filed: Nov. 28, 2001

(51) Int. Cl. B64B 1/40; B64B 1/58; F41J 9/08

(52) U.S. Cl. 244/31

(57) ABSTRACT

An air rescue assembly (20) having a balloon (110) adaptable to be filled with a gas to suspend an object (138) in the atmosphere for a predetermined amount of time is disclosed. The air rescue apparatus includes a shroud (120) substantially enclosing the balloon, a harness (136) selectively attachable to the object, and an attachment assembly (130) extending between the shroud and the harness.

### FIELD OF THE INVENTION

The present invention relates generally to an airborne ejection and recovery apparatus and, more particularly, to an air rescue apparatus that will suspend an object in the atmosphere to facilitate an air to air rescue.

### BACKGROUND OF THE INVENTION

Aircraft crew, such as pilots, rely on typical air rescue devices, such as parachutes, to provide for a safe descent to the ground when the abandoning of an aircraft becomes necessary. Although a typical parachute can slow the decent of an aircrew member to a safe velocity, it cannot eliminate the descent altogether. There are times when it is desirable to retrieve an aircrew member prior to its ultimate descent to the ground, such as when it is necessary to eject over hostile or inhospitable territory.

In order to prevent landing in hostile or inhospitable territory, an air-to-air rescue can be effected by a nearby rescue aircraft if the aircrew member's descent can be significantly slowed or eliminated altogether. By suspending the aircrew member at a specific altitude, the rescue aircraft can intercept and retrieve the aircrew member in an air-to-air rescue, thereby minimizing the possibility of the aircrew member landing in hostile territory after bailing out of an aircraft. Thus, there exists a need for an airborne rescue apparatus that suspends an aircrew member at a predetermined range of altitudes for an air-to-air rescue.

### SUMMARY OF THE INVENTION

In accordance with one embodiment of the present invention, an air rescue apparatus is provided. The air rescue apparatus includes a balloon adaptable to be filled with a gas to suspend an object in the atmosphere at a predetermined range of altitudes. The air rescue apparatus also includes a shroud substantially enclosing the balloon, and a harness selectively attachable to an object. The air rescue apparatus also includes an attachment assembly extending between the shroud and the harness.

In certain embodiments of the present invention, the balloon is a nonextensible balloon, such as a superpressure balloon. Such a nonextensible balloon does not expand as it rises, like a conventional balloon, but maintains a substantially fixed volume regardless of exterior pressure or interior pressure beyond a particular threshold. Because the total volume of the balloon does not vary with altitude, the balloon will naturally be suspended at the altitude where its volume displaces an equivalent mass of air as the mass of the payload. In this state of equilibrium, the apparatus will remain at this altitude for an extended period of time.

In accordance with other embodiments of the present invention, the balloon can be deployed with helium gas or hydrogen gas. In still yet other embodiments, the apparatus can be calibrated to seek a specific target altitude once deployed. In one particular embodiment, the air rescue apparatus is calibrated to maintain an altitude of 10,000 feet. At this altitude, the suspended object is an easy target for aerial recovery without being a target for ground fire.

### BRIEF DESCRIPTION OF THE DRAWINGS

The foregoing aspects and many of the attendant advantages of this invention will become better understood by reference to the following detailed description, when taken in conjunction with the accompanying drawings, wherein:

FIG. 1 is an environmental view of an air rescue apparatus formed in accordance with one embodiment of the present invention;

FIG. 2 is an environmental view of a pilot ejecting from an aircraft and deploying an air rescue apparatus formed in accordance with one embodiment of the present invention; and

FIG. 3 illustrates an environmental view of a pilot suspended by an air rescue apparatus formed in accordance with one embodiment of the present invention awaiting air-to-air interception and retrieval.

### DETAILED DESCRIPTION OF THE PREFERRED EMBODIMENT

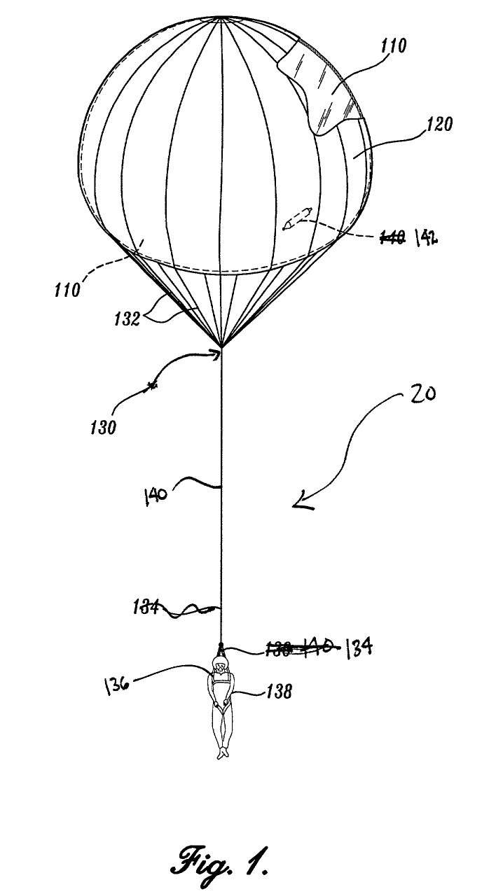

FIG. 1 illustrates one embodiment of an air rescue assembly 20 formed in accordance with one embodiment of the present invention. The air rescue assembly 20 includes a balloon 110, a shroud 120 enveloping the balloon 110, and an attachment assembly 130 attached to the shroud 120. The balloon 110 is suitably five meters in diameter and is capable of being inflated with gas. Although five meters is a suitable dimension for the balloon 110, it should be apparent that the size of the balloon depends upon the mass of the object to be suspended. As a non-limiting example, the diameter, and therefore, the volume of a balloon used to suspend a single person will be less than that of a balloon used to suspend an object of substantially greater mass. Thus, while a balloon of five meters in diameter is suitable for purposes of the present invention, balloons of greater or lesser diameter are also within the scope of the present invention.

In one embodiment, the balloon 110 is made of an extensible material. An extensible material will stretch to assume a volume, wherein the weight of the volume of gas inside the balloon 110 is equivalent to the weight of air displaced by the volume of the balloon 100.

In another embodiment, the balloon 110 is made of a non-extensible material. A nonextensible material has a substantially constant volume and, therefore, the volume of the balloon will not vary. (To overcome the diurnal cycle, a non-extensible material maintains the temperature of gas within the balloon, such that it does not heat up excessively during the day nor cool down at night. Variations in the air pressure caused by the heat of the sun or cool of the night produce changes in the internal gas pressure, but the volume of the balloon remains fixed.) So long as the balloon remains under pressure, it continues to float at its predetermined constant density level. The gas used to inflate the balloon 110 is preferably helium in one particular embodiment. Although helium is preferred, any gas lighter than the ambient air to a degree capable of suspending the total weight of a payload and the air rescue apparatus, such as hydrogen, is also within the scope of the present invention.

The shroud 120 is a typical rescue parachute that envelopes the balloon 110, and is suitably formed from a well known material, such as ripstop nylon. The shroud 120 is draped over the balloon 110, such that the edge of the shroud 120 hangs down toward a suspended payload below. In one particular embodiment, the edge of the shroud 120 hangs down past the lower surface of the balloon 110. Connected to the edge of the shroud 120 is the attachment assembly 130.

The attachment assembly 130 includes a plurality of reins 132, an aerial retrieval portion 140, and a bridle 134. Each rein 132 is suitably formed as a cord from a high strength material. One end of each rein 132 is connected to the edge of the shroud 120 by a well known fastener, such as an eye ring. The other end of each rein 132 is fastened to one end of the aerial retrieval portion 140 by a well known fastener. The reins 132, as attached, assist in securing the shroud 120 around the lower surface of the balloon 110, thereby substantially encasing the balloon 110 within the shroud 120.

The aerial retrieval portion 140 is suitably a cord of high strength material. The aerial retrieval portion 140 extends between the reins 132 and the bridle 134. In one embodiment of the present invention, the aerial retrieval portion 140 is 25 meters in length. It should be apparent that while the preferred length of the aerial retrieval portion 140 is 25 meters, other lengths sufficient to provide a safe aerial recovery of a suspended object are also within the scope of the present invention. Factors considered in determining a sufficient length of the aerial retrieval portion include minimizing the risk of a suspended object from becoming entangled with the aircraft and providing a target that permits both day and nighttime recovery of the suspended object by the recovery aircraft. An aerial retrieval portion 140 of such lengths distances an air crew member from the balloon, such that an aircraft 320 may make an air-to-air recovery of the aircrew member 130, as is described in more detail below.

The bridle 134 is connected to the harness 136 that in one embodiment is adaptable to support the aircrew member 138. Although it is preferred that the harness 136 is adapted to support the weight of a human, it should be apparent that harnesses adapted to support other objects, such as a piece of cargo, are also within the scope of the present invention.

One or more tanks of pressurized gas 142 are used to fill the balloon 110 with gas when the air rescue assembly 20 is deployed. Each of the tanks of pressurized gas 142 is suitably disposed within the balloon 110. Although the present embodiment of the air rescue assembly 20 illustrates one tank of pressurized gas 142 as being disposed within the balloon 110, the invention is not intended to be so limited. Thus, it should be apparent that the location of any of the tanks of pressurized gas 140 are not important to the invention and, therefore, any tank of pressurized gas 140 may be located in other locations to optimize the invention.

After deployment, the air rescue assembly 20 will seek a state of equilibrium in the atmosphere. Because the gas inside the balloon 110 is lighter than air, the entire system and the payload will be suspended at an altitude whereby the mass of the air rescue assembly 20, including the aircrew member 138, is equal to the mass of air that is displaced by the balloon 110. In one particular embodiment, the altitude sought to be deployed at is 10,000 feet above sea level. At this altitude, the suspended payload in an easy target for an air-to-air interception and retrieval without being a target for ground fire. A suitable range of altitudes is 100 feet above sea level to 50,000 feet above sea level.

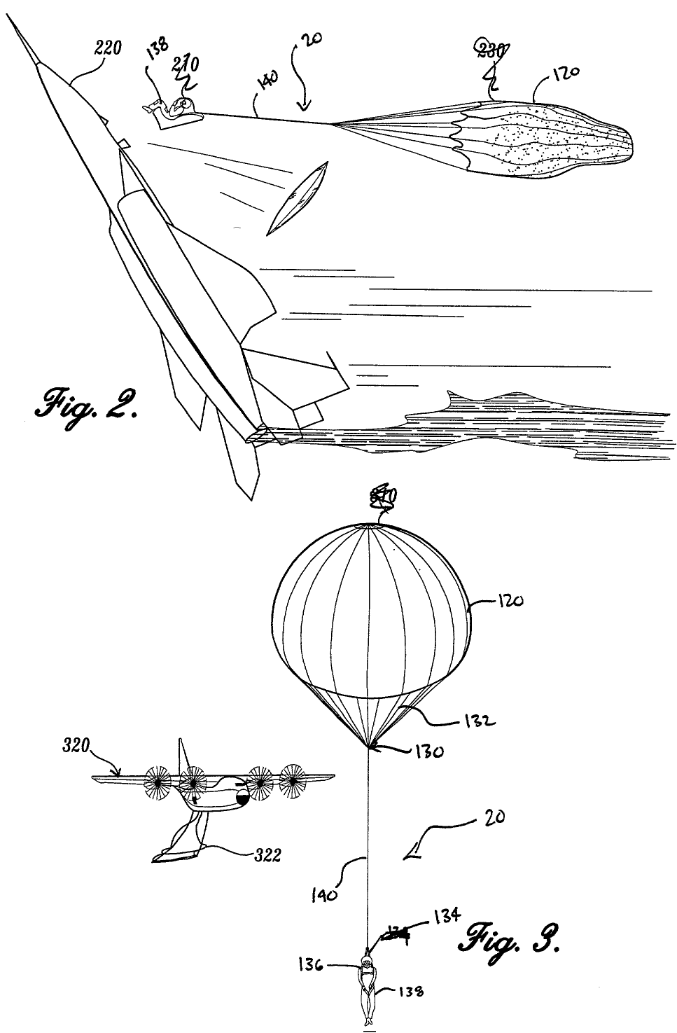

FIG. 2 illustrates an aircrew member 138 ejecting from the aircraft 220 and deploying the air rescue assembly 20. Deployment of the air rescue assembly 20 may be accomplished either manually or automatically upon actuation of an ejection sequence. Before the air rescue assembly 20 is deployed, it may be stowed in a wearable backpack. In another embodiment, the air rescue assembly 20 may be stowed behind the pilot and attached to the pilot's aircraft seat. The air rescue assembly 20 remains dormant until ejection from the aircraft 220. Upon ejection from the aircraft 220, the tank of pressurized gas 142 fills the balloon 110 with the gas, thereby rapidly filling the volume of the balloon 110.

Once the air rescue assembly 20 has been deployed and the apparatus has reached a state of equilibrium, i.e., the altitude in which the total weight of the balloon and payload is equivalent to the weight of the volume of air that is displaced, the payload is in a position to be intercepted and retrieved by a rescue aircraft via an air-to-air rescue. This is depicted in FIG. 3. A rescue aircraft 320, shown as a C-130, can be equipped with a catching assembly 322, whereby the rescue aircraft 320 flies in a path above the balloon 110 and “catches” the aerial retrieval portion 140 in a net connected to the catching assembly 322. After the aerial retrieval portion 140 is intercepted by the net, the payload can be retrieved into the rescue aircraft 320. The air rescue assembly 20 enables a payload to remain at a predetermined altitude thereby significantly increasing the accuracy and success rate of an air-to-air rescue.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. An air rescue apparatus, comprising:
(a) a balloon adaptable to be filled with a gas to suspend an object in the atmosphere at a predetermined range of altitudes;
(b) a shroud substantially enclosing the balloon;
(c) a harness selectively attachable to an object; and
(d) an attachment assembly extending between the shroud and the harness.

2. The air rescue apparatus of claim 1, wherein the balloon is nonextensible.

3. The air reuse apparatus of claim 1, wherein the balloon is extensible.

4. The air rescue apparatus of claim 1, wherein the balloon is filled with helium gas.

5. The air rescue apparatus of claim 1, wherein the balloon is filled with hydrogen gas.

6. An air rescue apparatus, comprising:
(a) a nonextensible balloon adaptable to be filled with a gas to suspend an object in the atmosphere for a predetermined amount of time at a predetermined range of altitudes;
(b) a shroud enveloping the balloon; and
(c) an attachment assembly extending between the shroud and a harness, wherein the harness is selectively attachable to an object.

7. The air rescue apparatus of claim 6, wherein the nonextensible balloon is filled with helium gas.

8. The air rescue apparatus of claim 6, wherein the nonextensible balloon is filled with hydrogen gas.

9. An air rescue apparatus comprising:
(a) suspension means for suspending an object at a predetermined range of altitudes, the suspension means, comprising:
(i) a nonextensible container adapted to be selectively filled with a gas; and
(ii) a shroud assembly substantially surrounding the nonextensible container;
(b) a harness adapted to be selectively attachable to a person; and
(c) an attachment assembly extending between the harness and the suspension means, the attachment assembly including an aerial retrieval portion adapted to be captured by an airborne vehicle to retrieve the person suspended from the air rescue apparatus.

10. The apparatus of claim 9, wherein the nonextensible container is a superpressure balloon filled with helium gas.

11. The apparatus of claim 9, wherein the nonextensible container is a superpressure balloon filled with hydrogen gas.
